(19) United States
(12) Patent Application Publication
(10) Pub. No.: US 2008/0114634 A1
(43) Pub. Date: May 15, 2008

(54) METHOD, SYSTEM, AND COMPUTER PROGRAM PRODUCT FOR DETERMINING AVAILABILITY AND ORDER SCHEDULING OF DIVERSE PRODUCTS AND SERVICES

(75) Inventors: Kenneth Cyprys, Chappaqua, NY (US); Jeffrey J. Hoyt, Clintondale, NY (US); Joseph P. DeMarco, Newburgh, NY (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/559,122

(22) Filed: Nov. 13, 2006

(51) Int. Cl. G05B 19/418

(52) U.S. Cl. 705/8

(57) ABSTRACT

A method, system, and computer program product for determining availability and order scheduling of diverse products and services is provided. The method includes receiving an order with a plurality of element orders. The element orders are organized into one or more delivery groups. A first pass alignment date is determined for each element order, and the element orders are distributed to one or more scheduling applications in a first pass. The method also includes collecting a first pass response from the one or more scheduling applications, and the first pass response includes first pass element availability dates. The method further includes determining a second pass alignment date, including aligning the first pass element availability dates for the element orders in each delivery group, and communicating the second pass alignment date.

### BACKGROUND OF THE INVENTION

The present disclosure relates generally to managing an order, and, in particular, to a method, system, and computer program product for determining availability and order scheduling of diverse products and services.

In today's competitive environment, companies are required to provide complete solutions to a customer's wants and needs. In some cases this may mean providing products and services that are diverse in nature. A seller may have to provide products and services that are not internal core competencies. In such a case, a primary seller often manages an order by subcontracting pieces of the solution to secondary sellers, such that the customer may receive all requested products and services in a coordinated manner. Due to diversity in systems and methods used by various sellers of products and services, the primary seller may invoke manual processes to consolidate the information into a response to the client. The use of manual processes can be time consuming and costly, particularly when multiple sellers and dependent transactions are involved.

Accurate expectation setting between a seller and a customer, both during the sales proposal process and just prior to order entry, is another important capability for avoiding customer dissatisfaction. A common approach to expectation setting is to reserve supply for a customer based upon a sales proposal to ensure that the supply will be available for the customer. However, expectation setting through actual supply reservation may be problematic due to time lags for approvals and decision-making between solution proposal and order entry. Furthermore, premature supply reservation may interfere with other orders that are ready for execution, or result in holding excessive inventory.

Systems have been contemplated wherein order simulation is performed on a simulation system to avoid conflicting with actual orders on an ordering system. This technique may avoid premature supply reservation, but it is costly due to the need for multiple systems. Other systems have been contemplated that coordinate acquisitions from multiple suppliers, but fail to optimize scheduling between the suppliers. Such systems do not contemplate managing the dependencies between suppliers in determining an optimal schedule.

Accordingly, there exists a need for an integrated method of managing an order to coordinate the scheduling of core and subcontracted products and services, while setting customer shipment and delivery expectations without actual reservation of supply.

### BRIEF SUMMARY OF THE INVENTION

The shortcomings of the prior art are overcome and additional advantages are provided through the provisions of a method, system, and computer program product for determining availability and order scheduling of diverse products and services. The method includes receiving an order with a plurality of element orders. The element orders are organized into one or more delivery groups. A first pass alignment date is determined for each element order, and the element orders are distributed to one or more scheduling applications in a first pass. The method also includes collecting a first pass response from the one or more scheduling applications, and the first pass response includes first pass element availability dates. The method further includes determining a second pass alignment date, including aligning the first pass element availability dates for the element orders in each delivery group, and communicating the second pass alignment date. The element orders may include a combination of product and/or service orders. The method may support both orders and simulated orders.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a system upon which determining availability and order scheduling of diverse products and services may be implemented in exemplary embodiments;

FIG. 2 is a flow diagram describing a process for implementing scheduling coordination in exemplary embodiments;

FIG. 3 is a flow diagram describing a process for implementing availability simulation in exemplary embodiments;

FIG. 4A depicts an example relationship between a customer and sellers, where the customer manages coordination of deliveries; and

FIG. 4B depicts an example relationship between a customer, a primary seller, and secondary sellers, where the primary seller may determine availability and order scheduling of diverse products and services in exemplary embodiments.

The detailed description explains the preferred embodiments of the invention, together with advantages and features, by way of example with reference to the drawings.

### DETAILED DESCRIPTION OF THE INVENTION

A customer may desire to purchase multi-brand solutions through a primary seller, rather than manage the task of purchasing products and services from multiple sellers. Accordingly, the primary seller needs to coordinate shipment and delivery of products and services both from within and beyond the core competency of the primary seller. Further, as companies diversify or acquire other companies, they inherit information systems tailored to the specific functionality of the legacy business. Migrating to a new application can prove costly. It may be particularly difficult to create new applications that are sufficiently robust to handle complexities that have been designed into a legacy system. At the same time, there may be a need to merge the capabilities of various applications to derive a single response or solution for a customer.

The inventive principles described further herein enable a company to maintain its individual business unit applications and methods of scheduling, while the results are incorporated and coordinated with those of other business units. The resulting coordination of the various scheduling applications provides a cohesive response back to the customer, and provides the ability of the individual business units to integrate their products and services into the entire solution. An order placed by a customer through a primary seller may also be referred to as a solution order, where the primary seller undertakes fulfilling a customer request that includes multiple element orders. Element orders refer to orders for products or services that are parts of the larger solution order. The element orders may be coordinated through the primary seller and targeted to specific business units that may fulfill each element order. The primary seller may consolidate the elements supplied by business units, such that the customer may receive groups of products and/or services.

The inventive principles further enable the ability to deliver products and services in predefined groups, referred to as delivery groups, independent of the supplying business unit. Multiple delivery groups may be managed with respect to dependency relationships between the delivery groups. Further capabilities for managing an order include checking supply availability without supply reservation through a simulated order, as well as scheduling order execution with supply reservations across multiple business units. Both the availability checking and scheduling of an order may benefit from a two pass process of aligning element order dates based on delivery groups and other rules, attempting a first pass of scheduling with the business units, and re-aligning the dates based on the first pass results. Order scheduling may be completed through a second pass of scheduling with the business units, using the re-aligned dates.

The inventive principles can be applied to all phases of a purchasing process. The purchasing process can be further decomposed into learning, shopping, and buying processes. During the learning process, a customer typically searches for or browses through information about various products or services available for purchase. The learning process may also include acquiring product datasheets, reviews, and other information that may ultimately influence a final purchase decision. In the shopping process, a customer may customize and select products or services with an intention of making a purchase. Throughout the buying process, a customer may place selected products or services in a shopping cart, for temporary holding, and then complete the purchase.

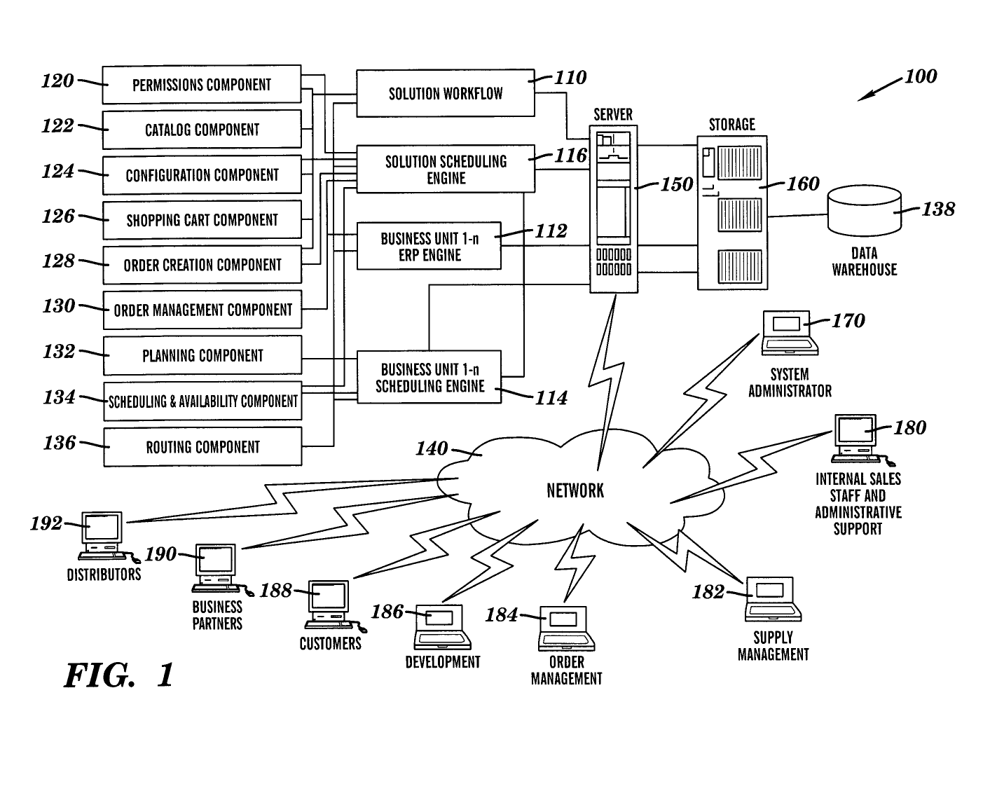

Turning now to FIG. 1, a system 100 upon which determining availability and order scheduling of diverse products and services may be implemented will now be described in accordance with exemplary embodiments. A server system 150 is connected to a storage system 160, a data warehouse 138, and to client systems 170-192 through a network 140. The network 140 may be a local area network (LAN), a wide area network (WAN), the Internet, or any other network configuration known in the art. The network 140 may include wireless connections, radio based communications, telephony based communications, or other network-based communications. Secure socket layer (SSL) software may be used to control access to the server system 150, limiting permissions to network users, such as client systems 170-192, who have proper authorization.

The client systems 170-192 may include: a system administrator client system 170, an internal sales staff and administrative support client system 180, a supply management client system 182, an order management client system 184, a development client system 186, a customer client system 188, a business partner client system 190, and a distributor client system 192. The client systems 170-192 may be general-purpose computer devices that allow systems to connect to the network 140 and the server system 150. The client systems 170-192 may access the server system 150 via Web browsers. The client systems 170-192 may include any suitable computer systems, such as IBM's ThinkPad™ or ThinkCentre™. Individuals or teams involved in the selling or management of products and services may perform specific roles throughout the described process. The individuals or teams may be in communication with each other via the client systems 170-192, as will be described further herein. It will be understood that there may be multiple client systems of each type depicted in FIG. 1. Furthermore, the client systems 170-192 may be combined into multiple subsystems or a single system without departing from the scope of the invention.

The server system 150 may include an IBM® eServer™ iSeries™, pSeries™, xSeries™ or zSeries™ or other suitable computer systems depending on the scope of implementation. The server system 150 may execute Web server software designed to accommodate various forms of communications, including voice, video, and text typically utilized by large business enterprises. Any Web server software or similar program that handles general communication protocols and transport layer activities may be used as appropriate for the network protocol in use. For purposes of illustration, server system may execute IBM's Lotus Domino™ and Lotus Notes™ as its groupware application software; however, any compatible e-mail-integrated, Web-enabled collaborative software could be used.

The server system 150 may execute a solution workflow 110, business unit enterprise resource planning (ERP) engines 112, business unit scheduling engines 114, and a solution scheduling engine 116. In exemplary embodiments, the server system 150 may execute the data warehouse 138. In alternate exemplary embodiments, the data warehouse 138 may be executed on an alternate platform to which the server system 150 is communicably coupled. In exemplary embodiments, multiple components (e.g., software modules), including both Web components and non-Web components, are used to support applications executing upon the server system 150. The components include: a permissions component 120, a catalog component 122, a configuration component 124, a shopping cart component 126, an order creation component 128, an order management component 130, a planning component 132, a scheduling and availability component 134, and a routing component 136. For purposes of illustration, the non-Web components could utilize IBM's Lotus 1-2-3™ spreadsheets, DB2® databases, or other suitable data intense manipulation programs.

The solution workflow 110 may be a Web based application that provides the customer client system 188, the business partner client system 190, the distributor client system 192, and the internal sales staff and administrative support client system 180 with the ability to collect product and service information. The information includes price and quantity used for order processing. The solutions workflow 110 includes six components: the permissions component 120, the catalog component 122, the configuration component 124, the shopping cart component 126, the order creation component 128, and the routing component 136. The internal sales staff and administrative support client system 180 manages the solution workflow 110.

The solution scheduling engine 116 may be an application that coordinates the scheduling or availability requests from the customer client system 188, the business partner client system 190, the distributor client system 192, and the internal sales staff and administrative support client system 180. In exemplary embodiments, the solution scheduling engine 116 provides arrival dates for delivery groups, determines which business unit scheduling systems to route the order to, and aligns the delivery of an order when results are obtained. Furthermore, the solution scheduling engine 116 may monitor for a change in a customer request date or a product or service arrival date. The solution scheduling engine 116 may determine if the date for an entire solution or an individual product or service should be adjusted. The business unit scheduling applications and the customer may be notified if changes are necessary. The solution scheduling engine 116 includes six components: the permissions component 120, the configuration component 124, the order creation component 128, the order management component 130, the scheduling and availability component 134, and the routing component 136. The internal sales staff and administrative support client system 180 manages the solution scheduling engine 116.

The business unit ERP engines 112 may be internal or external automated systems that manage numerous enterprise functions, including the order management component 130. Orders are submitted from the solution scheduling engine 116 to the business unit ERP engines 112 for production and fulfillment processing using the routing component 136. The business unit ERP engines 112 pass key order attribute information to the business unit scheduling engines 114. The order management client system 184 manages the business unit ERP engines 112.

The business unit scheduling engines 114 may be internal or external automated systems, which are connected to both the planning component 132 and the scheduling and availability component 134. The business unit scheduling engines 114 receive key order attribute information from the business unit ERP engines 112. The business unit scheduling engines 114 also receive scheduling information from the solution scheduling engine 116 via the routing component 136. The supply management client system 182 manages the business unit scheduling engines 114.

The permissions component 120 may be an automated system used for user log in and password entry into the solution workflow 110 and/or the solution scheduling engine 116 for the internal sales staff and administrative support client system 180, the development client system 186, the customer client system 188, the business partner client system 190, and the distributor client system 192. The permissions protect key business information and provide appropriate entitled data to specific users. The internal sales staff and administrative support client system 180 manages the permissions component 120.

The catalog component 122 may be an automated system used to provide product and service information during the learning process for the internal sales staff and administrative support client system 180, the customer client system 188, the business partner client system 190, and the distributor client system 192. The product and service offering information may be provided and managed by the development client system 186. Availability lead-time messages from the scheduling and availability component 134 may be provided automatically to the catalog component 122 by an event driven service oriented architecture. In exemplary embodiments, product and service offering information is transmitted from the catalog component 122 to the configuration component 124 or the shopping cart component 126.

The configuration component 124 may be an automated system used to customize product and service offering information during the shopping process, tailored to the needs of the internal sales staff and administrative support client system 180, the customer client system 188, the business partner client system 190, and the distributor client system 192. The configuration component 124 may be devised and managed by the development client system 186. Availability lead-time messages from the scheduling and availability component 134 may be provided automatically to the catalog component 122 by an event driven service oriented architecture. In exemplary embodiments, product and services offering information from the catalog component 122 is processed through the configuration component 124 and transmitted to the shopping cart component 126.

The shopping cart component 126 may be an automated system used to hold and submit order entry information during the buying process for the internal sales staff and administrative support client system 180, the customer client system 188, the business partner client system 190, and the distributor client system 192. Availability information from the scheduling and availability component 134 may be provided in the shopping cart component 126. In exemplary embodiments, the shopping cart component 126 also receives fulfillment information such as payment method, ship to address, billing, and other such information. When a completed order is submitted, it is transmitted to the solution workflow 110.

The order creation component 128 may be an automated system used to organize an order or availability request so that it can be processed by the solution scheduling engine 116 and the business unit ERP engines 112. Information provided by the order creation component 128 may be used within the solution workflow 110 by the internal sales staff and administrative support client system 180 to satisfy order requirements from the customer, business partner, and distributor client systems 188-192.

The order management component 130 may be an automated system used to provide order fulfillment information to the business unit ERP engines 112 for processing. The order management component 130 may include management of new orders, from order entry through installation. In exemplary embodiments, the order management component 130 controls the order information flow between the solution workflow 110, the business unit ERP engines 112, the business unit scheduling engines 114, and the solution scheduling engine 116. The order management component 130 communicates the successful execution of order processing to the internal sales staff and administrative support client system 180, the customer client system 188, the business partner client system 190, and the distributor client system 192. The order management client system 184 maintains the order management component 130.

The planning component 132 may be an automated system used to provide an initial supply position to the business unit scheduling engines 114, which is communicated by suppliers to the seller based on a demand forecast. Customers, distributors, and business partners may be assigned to tiers based on seller prioritization rules. In exemplary embodiments, supply is allocated based on business practices, such as geography, customers, tiers, and the like. The supply management client system 182 maintains the planning component 132.

The scheduling and availability component 134 may be an automated system used to determine product and service availability based on scheduling rules. In exemplary embodiments, the scheduling and availability component 134 is updated on a periodic basis based on net available supply and the business unit scheduling engine's 114 business rules, such as customer tiering, allocations, and brokering schema. Lead-time messages contained in the scheduling and availability component 134 may be updated on a periodic basis. The scheduling and availability component 134 may also contain simulation information represented as shipment or arrival dates for a specified quantity. Simulation information comes from the business unit's scheduling engines 114 and represents current supply availability. The supply management client system 182 maintains scheduling and availability component 134.

The routing component 136 may be an automated system used to route the scheduling, availability simulation, and other order information to the appropriate business unit ERP engines 112, business unit scheduling engines 114, and solution scheduling engine 116. The routing component 136 also creates initial pseudo order numbers that are used by the business unit scheduling engines 114 to create an order. The order management client system 184 maintains the routing component 136.

The storage system 160 of FIG. 1 may be any form of mass storage device configured to read and write database-type data maintained in a file store, such as a magnetic disk data storage device. The storage system 160 may range from a single hard disk drive on a personal computer to a large enterprise storage systems, such as IBM's Shark™. It will be appreciated that the storage system 160 may include multiple disk subsystems, which may be geographically dispersed and coupled via network architecture. The storage system 160 may be logically addressable as a consolidated data source across a distributed environment such as a network system. The implementation of local and wide-area database management systems to achieve the functionality of the storage system 160 will be readily understood by those skilled in the art. Information stored in the storage system 160 may be retrieved and manipulated by a database manager and data mining software. For purposes of illustration, the database manager may be IBM's DB/2® software or Lotus Notes™ team rooms. The storage system 160 may provide a repository for a library of documents, and data that are created and utilized within the system 100.

In exemplary embodiments, the system administrator client system 170 refers to a client system operated by an individual or team that manages the performance, operation, and maintenance of the server system 150, the storage system 160, and the network 140.

In exemplary embodiments, the internal sales staff and administrative support client system 180 controls and manages the permissions component 120 and the shopping cart component 126 to ensure that the customer, business partner, and distributor client systems 188-192 access only entitled information within the solution workflow 110. The internal sales staff and administrative support client system 180 may also enter orders by using the catalog, configuration, and shopping cart components 122-126. The internal sales staff and administrative support client system 180 may grant full access or limited access to availability information within the internal domain.

In exemplary embodiments, the supply management client system 182 controls and manages the business unit scheduling engines 114, the planning component 132, and the scheduling and availability component 134, which includes the development of net available supply, allocations, and the like.

In exemplary embodiments, the order management client system 184 controls and manages the business unit ERP engines 112 and the order management component 130 to receive orders from the shopping cart component 126. The order management client system 184 also transmits data to the solution scheduling engine 116 via the solution workflow 110.

In exemplary embodiments, the development client system 186 provides and manages product and services offering information. The development client system 186 also controls the configuration component 124.

The customer, business partner, and distributor client systems 188-192, respectively, may obtain information throughout the learning, shopping, and buying processes, via the permissions component 120, through the following components: the catalog component 122, the configuration component 124, the shopping cart component 126, the order management component 130, and the scheduling and availability component 134. The customer client system 188 may enter an order by using the catalog, configuration, and shopping cart components 122-126, or by using the internal sales and support staff client system 180 to collect the necessary information.

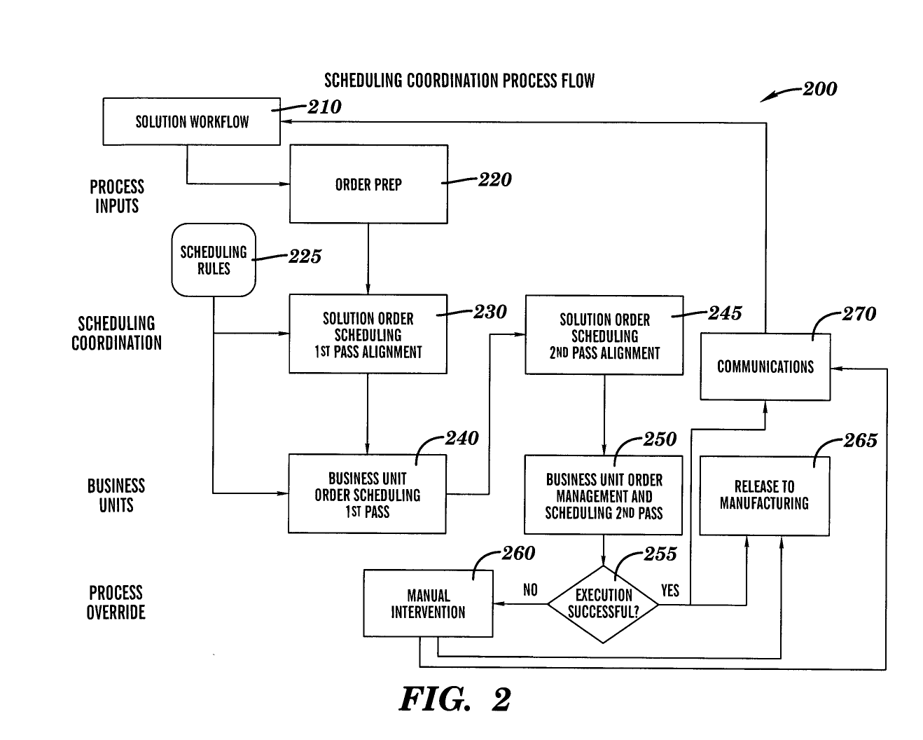

Turning now to FIG. 2, a process 200 for implementing scheduling coordination will now be described in accordance with exemplary embodiments. When an order arrives from a customer, such as the customer client system 188, a solution workflow process collects and maintains the relevant information about the order at step 210. The solution workflow process of step 210 may be implemented by the solution workflow 110 of FIG. 1. The information about the order may include product and service identifiers, quantity, customer requested arrival dates (CRADs), delivery groups, a consolidation center, lead-time offsets, etc. In exemplary embodiments, a delivery group includes products and/or services that the customer has requested to be delivered at about the same time. A consolidation center may be a location used to bundle products together for common delivery. Lead-time offsets may be used to maintain dependency relationships between elements in a delivery group and between delivery groups. For example, an installation service for a product should not arrive before the product arrives.

When the order is ready for scheduling, the order is passed by the front-end order management component 130 to an order preparation process at step 220. Within the order preparation process of step 220, a unique solution order identification number is assigned to the order. The order is passed using the routing component 136 to a solution order scheduling first pass alignment process at step 230.

The solution order scheduling first pass alignment process of step 230 pulls in reference data using scheduling rules at step 225 to determine a business unit supply source for the order. In exemplary embodiments, the solution order scheduling first pass alignment process of step 230 also creates an element order number for each product or service within the solution order, coordinates a CRAD with each element order, and groups the element orders into delivery groups. The element orders may be grouped within a solution order according to specified directions established in the solution workflow process of step 210. The business unit supply source may be an organization providing products or services, sold through sales channels. The element order number may be an initial identifier used to track each element order. If the order needs to be consolidated prior to delivery, as determined by the order creation component 128, the solution scheduling engine 116 accounts for the lead-time required at the consolidation center and provides an interim date for the products to arrive at the consolidation center based upon an entity management of the order. The entity management is based on the customer requirements for delivery groups. Any resulting date shift from each CRAD is reflected in a first pass alignment date generated for each element order. Using the routing component 136, the order information is routed to a data warehouse 138 for collection of order management activities. The solution order scheduling first pass alignment process of step 230 transmits the element orders and the first pass alignment dates to an appropriate business unit order scheduling first pass process at step 240 via the routing component 136. There may be separate business unit order scheduling first pass processes for each business unit.

In the business unit order scheduling first pass process of step 240, each business unit receives an order for scheduling the products and services for which it is responsible. Using the availability and scheduling component 134, each business unit scheduling engine 114 generates a first pass element availability date as determined by supply availability or lead time for the order based upon the first pass alignment date for the element, and using the business unit's own scheduling rules of step 225. In exemplary embodiments, the first pass element availability date is the date that most closely meets the first pass alignment date for the element. If the element order is for a product or service that is capacity scheduled using a specific supply available for the element, a supply reservation may be made. Supply reservation sets aside a supply for a particular order, but the supply is not considered consumed until completion of the second pass process. In some cases, a business unit will not only provide a first pass element availability date for services, but will also provide alternative first pass element availability dates, in case the business unit's first pass element availability date cannot be used during the alignment process as part of the two pass scheduling process. The routing component 136 sends each business unit's results back to a solution order scheduling second pass alignment process at step 245.

In the solution order scheduling second pass alignment process of step 245, the solution scheduling engine 116 collects all the scheduling information results received from the business units. After all expected inputs are received, the solution scheduling engine 116 aligns the results to a second pass alignment date, which is typically the worst date of all the first pass element availability dates (e.g., the latest availability date). Elements within delivery groups may be aligned according to their respective delivery group, with delivery groups sequenced based upon order parameters. Desired time delays between delivery groups defined in the order preparation process of step 220 are taken into account during scheduling coordination. The second pass alignment dates are routed via the routing component 136 to a business unit order management and scheduling second pass process at step 250. There may be separate business unit order scheduling second pass processes of step 250 for each business unit.

The business unit order management and scheduling second pass process of step 250 sends aligned scheduling information to each business unit ERP engine 112 using the routing component 136. In exemplary embodiments, each business unit ERP engine 112 assigns a final element order number as a fulfillment order number, and passes the aligned schedule information to the appropriate scheduling applications using the scheduling and availability component 134 to initiate a second pass of the scheduling process. The business unit completes the scheduling process for the solution order based on the second pass alignment date. If a supply was previously reserved for a different date, the original supply may be freed up with a supply reserved for a new aligned date. At each business unit, reserved supply is considered consumed and not available for future orders after two pass scheduling.

At step 255, a check is performed to determine the success of the business unit order management and scheduling second pass process of step 250 in meeting an aligned date. If the second pass element availability date is misaligned with the second pass alignment date for any of the elements, a manual intervention process exception is invoked at step 260. The manual intervention process of step 260 may include a manual substitution of a different element order for an element order cannot meet the aligned date.

When scheduling is completed, the order is released to manufacturing in a release to manufacturing process at step 265 using the routing component 136, and a communications process is invoked at step 270. In the communications process of step 270, a notification is sent back to the solution workflow process of step 210, using the routing component 136, containing new order data and a message indicating whether the second pass alignment date was met. The message may be communicated to the customer. The communications process of step 270 may also send updated order information to the data warehouse 138.

If for any reason, the business unit scheduling engine 114 cannot schedule the element order to the second pass alignment date, an exception message is created in place of the confirmation message, and the manual intervention process of step 260 may be initiated for further analysis and resolution. After all element confirmation messages are received, the consolidation center may receive notification of the upcoming order via the communications process of step 270.

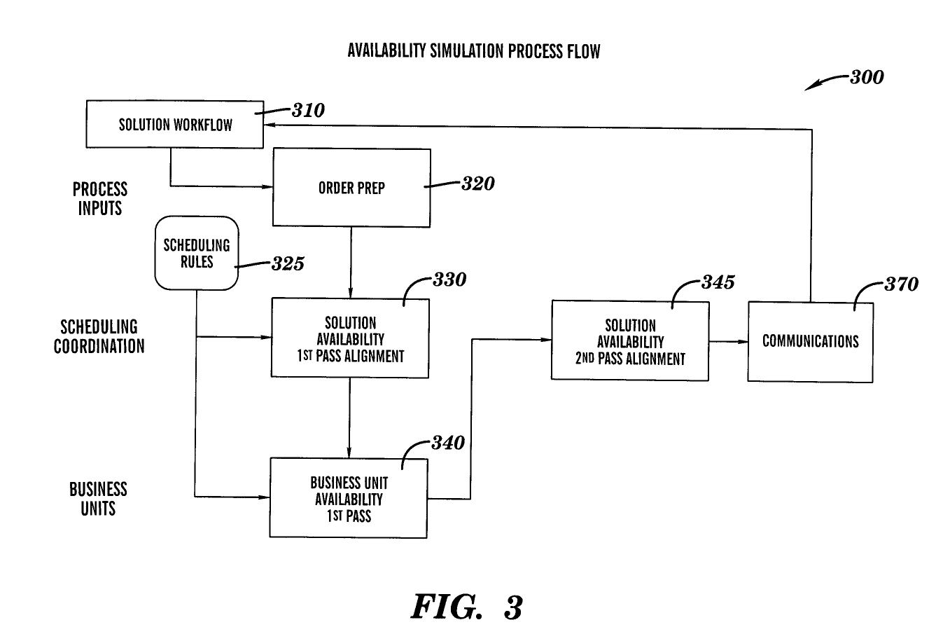

Turning now to FIG. 3, a process 300 for availability simulation will now be described in accordance with exemplary embodiments. In exemplary embodiments, a solution availability process 300 provides information about the availability of products and services prior to the actual ordering of a solution. The solution availability process 300 simulates the shipment dates that may be generated, if an order is submitted. In the description of the process 300, an order refers to a simulated order.

A solution workflow process collects and maintains relevant information about an order at step 310. The solution workflow process of step 310 may be implemented by the solution workflow 110 of FIG. 1. The information about the order may include product numbers, quantity, CRADs, delivery groups, consolidation center, lead-time offsets and the like. At the time an order is ready for an availability check, the order is passed to an order preparation process at step 320.

Within the order preparation process of step 320, a unique solution order identification number is assigned to the order. The order is passed using the routing component 136 to a solution availability first pass alignment process at step 330.

The solution availability first pass alignment process of step 330 determines the sources of supply to send the order to, creates an element order number for each product or service, and groups the element orders into delivery groups according to specified rules. If the order needs to be consolidated prior to delivery, as determined by the order creation component 128, the solution scheduling engine 116 may account for the lead time required at a consolidation center, and provide interim dates based upon entity management of the order. Any resulting date shift from each CRAD is reflected in a first pass alignment date generated for each element order. Using the routing component 136, the order information is routed to the data warehouse 138 for collection of order management activities. In exemplary embodiments, the element orders and the first pass alignment dates are prepared to send to a business unit availability first pass process at step 340. There may be separate business unit availability first pass processes for each business unit.

In the business unit availability first pass process of step 340, each business unit receives availability inquiries for the products and services for which it is responsible. Using the scheduling and availability component 134, each business unit determines the availability for each product or service within the inquiry using its own scheduling rules at step 325. No reservations of supply are made. In some cases, a business unit will not only provide the best date available as a first pass element availability date for the business unit's products and services, but also provides alternative dates in the event the best date cannot be met by the overall solution. The routing component 136 sends each business unit's results back to a solution availability second pass alignment process at step 345.

In the solution availability second pass alignment process of step 345, the solution scheduling engine 116 collects all of the scheduling information results from the business units. The solution availability second pass alignment process of step 345 aligns the results to a second pass alignment date, which is typically the worst date of all the first pass element availability dates (e.g., the latest availability date). Elements within logical delivery groups may be aligned according to their respective delivery group, with delivery groups sequenced based upon inquiry parameters. Time delays between delivery groups defined in the order preparation process of step 320 are taken into account during scheduling coordination. Once the solution availability second pass alignment process of step 345 is completed, a communications process is invoked at step 370.

In the communications process of step 370, a notification is sent back to the solution workflow process of step 310, using the routing component 136, containing new availability results and a message describing whether the aligned date was met. The message may be communicated to the customer. The customer may use the information to decide if alternative product or service selections are necessary.

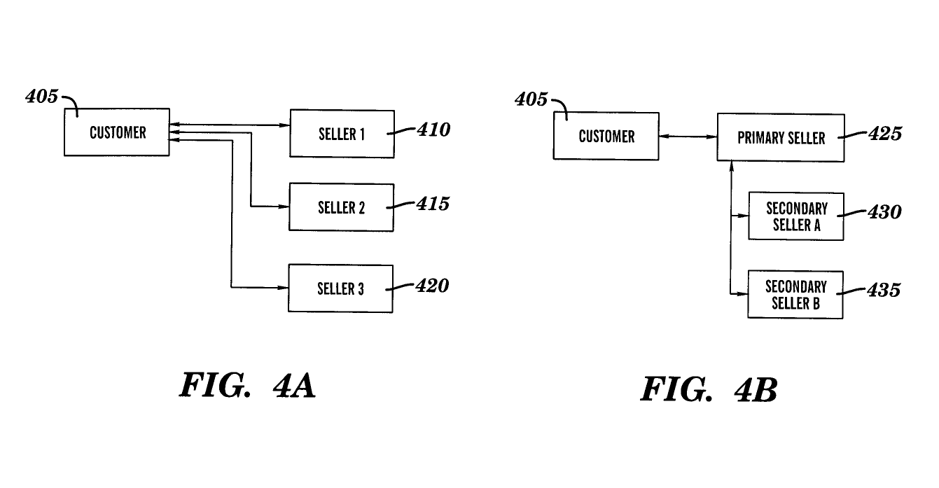

Turning now to FIG. 4A, an exemplary relationship between a customer 405 and multiple sellers 410-420 is depicted. Such a relationship may result from the customer's 405 desire to purchase a combination of products and services to solve a business problem. For example, the customer 405 may desire to purchase three servers and two installation service resources, fifty personal computers (PCs), and four resources to perform client help desk support. The customer 405 may request the business solution from any or all of the sellers 410-420, and discover that each seller may be able to provide part of the business solution. For example, seller 1 (410) may provide three servers and two installation service resources; seller 2 (415) may provide fifty PCs; and seller 3 (420) may provide four resources to perform client help desk support. Typically the customer 405 would contact each of the sellers 410, 415, and 420 and check for product and service availability, schedule each individual order, and coordinate delivery manually. While this approach is feasible, the customer 405 may prefer to deal with a single seller to provide a coordinated solution.

Turning now to FIG. 4B, an example relationship is depicted between a customer 405, a primary seller 425, and two secondary sellers 430 and 435. In accordance with exemplary embodiments, the primary seller 425 may determine availability and perform order scheduling of diverse products and services from secondary sellers 430 and 435 in an automated fashion. Returning to the previous example, the customer 405 may desire to purchase three servers and two installation service resources, fifty PCs, and four resources to perform client help desk support. Again, no individual seller may have all requested products and services within the seller's core business; however, the primary seller 425 may be able to provide a complete business solution to the customer 405 through the inventive principles described herein. For example, the primary seller 425 may directly provide the customer 405 with three servers and two installation service resources as part of its core business; the secondary seller A (430) may provide fifty PCs through the primary seller 425; and secondary seller B (435) may provide four resources to perform client help desk support through the primary seller 425.

Continuing with the example using the exemplary relationship depicted in FIG. 4B, the primary seller 425 may coordinate the business solution for the customer 405 using a two pass scheduling process to optimize the schedule and manage dependencies. The customer 405 may request installation of three servers at a central data center in three weeks; the installation date referred to herein as week 3. The customer 405 may also request installation of fifty PCs at two sales locations, with a first group of twenty-five installed during week 4 at sales location 1, and a second group of twenty-five installed during week 5 at sales location 2. Additionally, the customer 405 may request performance of services at the data center and sales locations. The services requirements at the data center may include two server installation resources, coordinated with the delivery of the servers. The two server installation resources may be requested at the data center for three weeks, weeks 3, 4, and 5. In addition, the customer 405 may request four resources to perform help desk support, with two at each of the sales locations. The help desk support resources may be requested at each sales location for four weeks upon the arrival of the PCs, resulting in two resources at sales location 1 for weeks 4-8, and two resources at sales location 2 for weeks 5-9. All of the requests may be combined into an order. The order of products and services may be grouped into delivery groups based upon timing and dependency relationships. For example, delivery group 1 may be the server installation and associated services. Delivery group 2 may be the delivery of the first group of twenty-five PCs and associated services for sales location 1. Delivery group 3 may be the delivery of the second group of twenty-five PCs and associated services for sales location 2.

Continuing with the example, the primary seller 425 of FIG. 4B may use the system 100 of FIG. 1 to perform the process 300 (FIG. 3) for availability simulation, and the process 200 (FIG. 2) for schedule coordination in accordance with exemplary embodiments. When the customer 405 makes an initial order inquiry for the business solution to the primary seller 425 through the system 100, the primary seller 425 may use the process 300 to determine whether the primary seller 425 and the two secondary sellers 430 and 435 can coordinate to meet the order through availability simulation. The primary seller 425 may determine that the order can be met through the process 300; however, no supply has been reserved. When the customer places the actual order, the primary seller 425 may invoke the process 200 to coordinate scheduling. Using the two pass scheduling process, the primary seller 425 may attempt to schedule all products and services through itself and the secondary sellers 430 and 435. Upon performing the first pass of the scheduling, the primary seller 425 may determine that the second group of twenty-five PCs targeted for location 2 as part of delivery group 3 are not available from the secondary seller B until week 6, rather than the original week 5 request. The supply problem has a cross dependency on the availability of the two help desk support resources within delivery group 3. During the second pass of scheduling in the process 200 on the system 100, the two help desk support resources within delivery group 3 may be requested for weeks 6-10, rather than 5-9, to coordinate the delay accordingly for both the PCs and the help desk resources in delivery group 3. Although this is only one example, it will be understood that such responsiveness to a customer order or order inquiry may be accommodated through a two pass process on the system 100 in either the process 300 for availability simulation or the process 200 for schedule coordination.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for managing an order, comprising:
receiving an order comprising of a plurality of element orders;
organizing the element orders into one or more delivery groups;
determining a first pass alignment date for each element order;
distributing the element orders to one or more scheduling applications in a first pass;
collecting a first pass response from the one or more scheduling applications, the first pass response including first pass element availability dates;
determining a second pass alignment date, comprising:
aligning the first pass element availability dates for the element orders in each delivery group; and
communicating the second pass alignment date.

2. The method of claim 1, wherein the element order is one of a product order and a service order.

3. The method of claim 1, wherein organizing the element orders into one or more delivery groups comprises:
aligning customer requested arrival dates for the element orders.

4. The method of claim 3, wherein determining a first pass alignment date for each element order comprises:
adjusting the customer requested arrival date for each element order to include a lead time offset.

5. The method of claim 1, wherein the second pass alignment date is communicated to one or more business unit enterprise resource planning (ERP) engines, and further comprising:
determining whether the second pass alignment date is met as an aligned date;
performing a manual intervention when the aligned date is not met; and
executing the order when the aligned date is met.

6. The method of claim 1, wherein the order is a simulated order.

7. The method of claim 1, wherein the second pass alignment date is communicated to a customer.

8. The method of claim 1, further comprising:
performing supply reservation, comprising:
setting aside a supply of an element order on the first pass of the scheduling application; and
consuming the supply of an element order on the second pass of the scheduling application.

9. A system for managing an order, comprising:
a server system;
a storage system device in communication with the server system;
one or more scheduling applications;
a solution scheduling engine executing on the server system, the solution scheduling engine performing:
receiving an order comprising of a plurality of element orders;
organizing the element orders into one or more delivery groups;
determining a first pass alignment date for each element order;
distributing the element orders to the one or more scheduling applications in a first pass;
collecting a first pass response from the one or more scheduling applications, the first pass response including first pass element availability dates;
determining a second pass alignment date, comprising:
aligning the first pass element availability dates for the element orders in each delivery group; and
communicating the second pass alignment date.

10. The system of claim 9, wherein the element order is one of a product order and a service order.

11. The system of claim 9, wherein organizing the element orders into one or more delivery groups comprises:
aligning customer requested arrival dates for the element orders.

12. The system of claim 11, wherein determining a first pass alignment date for each element order comprises:
adjusting the customer requested arrival date for each element order to include a lead time offset.

13. The system of claim 9, further comprising one or more business unit enterprise resource planning (ERP) engines; and
wherein the second pass alignment date is communicated to the one or more business unit enterprise resource planning (ERP) engines, and further comprising:
determining whether the second pass alignment date is met as an aligned date;
performing a manual intervention when the aligned date is not met; and
executing the order when the aligned date is met.

14. The system of claim 9, wherein the order is a simulated order.

15. A computer program product for managing an order, the computer program product including instructions for performing:
receiving an order comprising of a plurality of element orders;
organizing the element orders into one or more delivery groups;
determining a first pass alignment date for each element order;
distributing the element orders to one or more scheduling applications in a first pass;
collecting a first pass response from the one or more scheduling applications, the first pass response including first pass element availability dates;
determining a second pass alignment date, comprising:
aligning the first pass element availability dates for the element orders in each delivery group; and
communicating the second pass alignment date.

16. The computer program product of claim 15, wherein the element order is one of a product order and a service order.

17. The computer program product of claim 15, wherein organizing the element orders into one or more delivery groups comprises:
aligning customer requested arrival dates for the element orders.

18. The computer program product of claim 17, wherein determining a first pass alignment date for each element order comprises:
adjusting the customer requested arrival date for each element order to include a lead time offset.

19. The computer program product of claim 15, wherein the second pass alignment date is communicated to one or more business unit enterprise resource planning (ERP) engines, and further comprising:
determining whether the second pass alignment date is met as an aligned date;
performing a manual intervention when the aligned date is not met; and
executing the order when the aligned date is met.

20. The computer program product of claim 15, wherein the order is a simulated order.
